(19) United States
(12) Patent Application Publication
(10) Pub. No.: US 2010/0200497 A1
(43) Pub. Date: Aug. 12, 2010

(54) Method for Treating Percolate Water Produced During Dry Fermentation

(76) Inventor: Niels Holm, Minden (DE)

Correspondence Address: DIEDERIKS & WHITELAW, PLC, 13885 HEDGEWOOD DR., SUITE 317, WOODBRIDGE, VA, 22193, US

(21) Appl. No.: 12/702,701

(22) Filed: Feb. 9, 2010

(30) Foreign Application Priority Data
Feb. 10, 2009 (DE) 10 2009 008 254.9

(51) Int. Cl. C02F 3/30

(52) U.S. Cl. 210/605; 210/614

(57) ABSTRACT

Method for treating percolate water produced during, dry fermentation employs the following steps: charging a plurality of first fermentation chambers (F 1-F 5) from a first percolate water container (P 1) during a first period; charging a further fermentation chamber (F 6) from a second percolate water container (P 2) during the first period; feeding purified percolate water from the outlet/overflow of a sedimentation container (16) into the second percolate water container (P 2) or directly into a ferment chamber that is just being charged from the second percolation water container (P 1), from a plurality of ferment chambers (F 1-F 6) cyclically charged from the second percolate container (P 2); and feeding percolate water circulate from that ferment chamber in which the fermentation process has advanced furthest, into the percolate water container (P 2).

### BACKGROUND OF THE INVENTION

The invention relates to a method for biologically treating percolate water that is produced during dry fermentation of biowaste or other solid organic matter.

Biowaste without any appreciable foreign matter is used nowadays mainly as a fodder substitute or used energetically in biogas plants or communal digester plants; processing biowaste or renewable raw materials being dependent mainly on the composition of the respective material.

Biowaste with significant fractions of foreign matter, e. g. organic household waste, as they are produced in Germany in so-called biowaste containers, is usually processed in mechanical-biological waste treatment plants (MBA—mechanisch-biologischen Abfallbehandlungsanlagen). Here the organic fraction in this biowaste is reduced or stabilized after several different pretreatment steps and usually a last composting step, to an extent that subsequent deposition or use as compost is possible.

Prior to the composting step the waste fractions with a high enough content of organic constituents can be used for energy recovery in the form of dry fermentation in special digesters. In the process a large part of the organic fractions (referred to below as COD=chemical oxygen demand) is fermented under anaerobic conditions to produce biogas. Using the so-called percolate water recirculation process, fermentation is initiated or accelerated and optimized: During the fermentation process, highly-loaded wastewater (the so-called percolate water) leaches through the biowaste stack, is collected in the bottom area, and fed to a percolate water container. Recirculation then takes place from there by spraying the biowaste stack with the percolate water. Depending on the type and intensity of spraying biogas production takes place predominantly in the percolate water container or in the biowaste stack, however this is of no importance for the present invention.

In most cases an excess amount of highly-loaded percolate water of variable size is, produced as a function of the water content of the biowaste treated. No excess percolate water that must be disposed of is produced until this water content falls below a certain lower limit.

Otherwise the excess percolate water that is produced has to be treated further and/or disposed of. Since this excess percolate water is highly loaded with organic constituents (COD is often above 20 000 mg/L) and nitrogen compounds, further treatment or disposal is complex technically and expensive. The previous processes for further treatment take place externally without any connection with the upstream anaerobic biowaste fermentation.

Depending on the composition of the biowaste to be treated, percolate water is produced that may contain inhibitors than can inhibit biogas formation, for example by releasing or concentrating large amounts of ammonia. Further, the excess percolate water still contains large amounts of residual organic substances whose potential for producing biogas remains untapped. When the biowaste (including the percolate water) is removed from the digesters after anaerobic treatment, significant amounts of carbon dioxide and methane are still emitted into the atmosphere which has to be regarded as extremely negative in view of the climate problems. In the end the fully fermented biowaste is saturated with the raw percolate water which makes further treatment and/or disposal of this fully fermented biowaste difficult and expensive. As an example, highly-loaded leachate would be produced in a subsequent composting step.

### SUMMARY OF THE INVENTION

The object of the invention is therefore to provide a method where loading with percolate water is largely avoided.

This object is achieved—when a first percolate water container and a second percolate water container and a plurality of ferment chambers are used, one of which is in each case charged from the second percolate water container—by the following steps:

charging a plurality of first fermentation chambers from the first percolate water container during a first period, charging a further fermentation chamber from the second percolate water container during the first period, feeding purified percolate water from the outlet/overflow of a sedimentation container into the second percolate water container or directly into a ferment chamber that is just being charged from the second percolate water container, and feeding percolate water circulate from that ferment chamber in which the fermentation process has advanced furthest, into the percolate water container.

This method has the following advantages:
a) Loading of the excess percolate water is reduced to such an extent that the disposal costs of this further treated excess percolate water are sharply reduced. This is achieved for example by purifying the percolate water to indirect discharge quality.
b) The excess percolate water to be treated is integrated into the percolate recirculation of the dry fermentation process in such a way that the formation of biogas is increased by utilizing the residual organics and lowering the inhibiting effect of the raw percolate water.
c) The quality of the fully fermented biowaste is improved to such a degree that treating it further and/or disposing of it results in fewer costs,
d) carbon dioxide and methane emissions into the atmosphere are reduced considerably.

The sub-claims specify preferred embodiments of the invention.

### BRIEF DESCRIPTION OF THE DRAWINGS

The invention is explained below with reference to a drawing, in which

FIG. 1 shows a schematic illustration of an upstream denitrification method and

FIG. 2 shows a schematic illustration of charging the percolate water containers and the digester chambers.

### DETAILED DESCRIPTION OF THE INVENTION

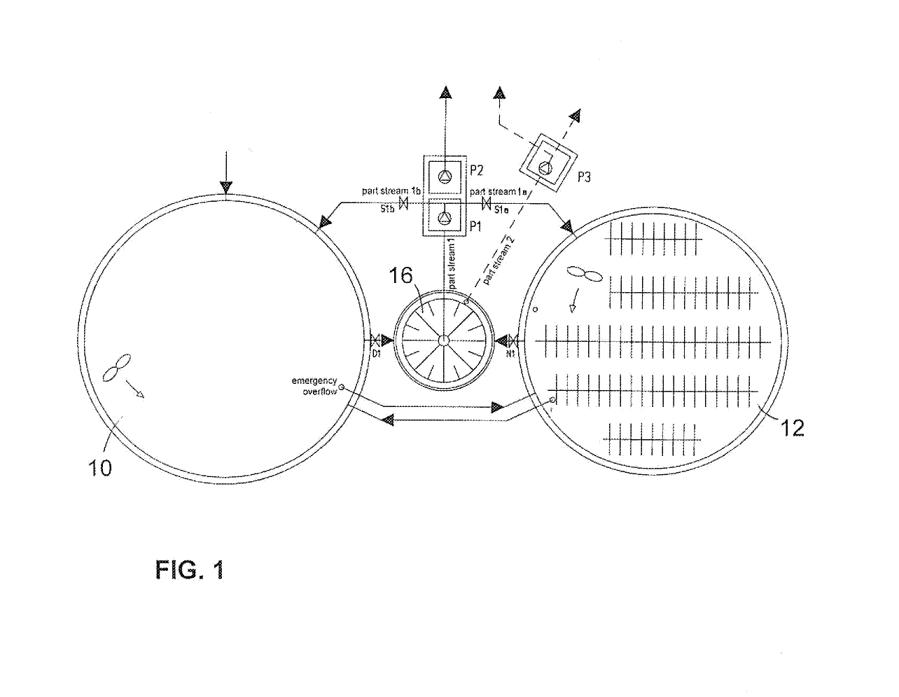

FIG. 1 shows that the percolate water is conveyed (from the percolate water container or one of the percolate water containers not shown in FIG. 1) into an upstream denitrification basin 10. Activated sludge from a downstream nitrification basin 12 is further conveyed into this denitrification basin 10 via internal recirculation (emergency overflow 14 from the nitrification basin 12 into the denitrification basin 10). In the denitrification basin 10, denitrification of the nitrate produced in the nitrification basin (12) takes place with the aid of the carbon sources fed from the percolate water.

Routing into the nitrification basin 12 does not take place directly, as is the case conventionally, but via an intermediate sedimentation basin 16 that is shown here as an example as a hopper-bottomed tank (Dortmund tank) that is being flown through horizontally. To this end the shut-off valve D1 is opened and the shut-off valve N1 is closed. A part stream 1 is withdrawn continuously from the apex of the sedimentation basin 16 and fed into the nitrification basin 12 via a pumping station P1 (part stream 1a); for this the shut-off valve S1a is opened and the shut-off valve S1b is closed. The remaining part stream 2 runs off into the pumping station P3 as supernatant liquid in which no or only a small amount of activated sludge is present. This part stream 2 that contains part of or the whole excess sludge of this activated-sludge stage that has been produced is fed back into the percolate water recirculation system of the upstream anaerobic dry fermentation and thus integrated.

Recirculation between denitrification and nitrification basins can take place in the reverse direction: for this only D1 and S1a are closed and N1 and S1b are opened. Recirculation then takes place from the nitrification basin into the denitrification basin. The respective return flows are shown in FIG. 1. Of importance in this context is that in the case of this process control, the part stream 2 originates from the nitrification basin 12 and therefore no longer contains any ammonia at all and is largely oxidized in terms of the dissolved carbon compounds. This water is therefore even better suited for percolate water leaching from the fermenting biowaste.

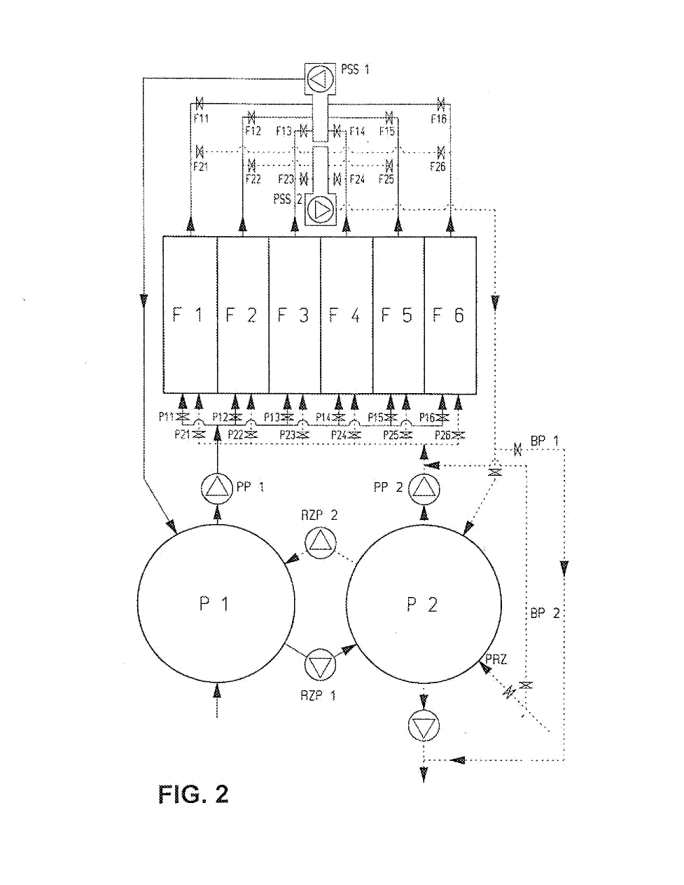

As is made clear by FIG. 1, the excess sludge of the aerobic biology that has been produced can be integrated into the dry fermentation process: by means of the pumping station P2 the excess sludge can be conveyed directly into a percolate water container (shown in FIG. 2). Using this novel process step between denitrification and nitrification basins the following process advantages are achieved:

1. Extreme sludge index selection (the sludge index ISV is a measure of the sedimentation rate of the activated sludge) takes place in the direction of a lower sludge index since the part stream 1 remaining in the system contains a disproportionately high content of fast settling flakes. This sludge index selection is based on the same principle of other sludge index selection methods (EP 1 634 854, EP 1 634 855, and EP 1 627 854 incorporated herein by reference), however the technical implementation is different.

On the basis of this ISV selection toward a very low ISV value the nitrification basin 10 and the denitrification basin 12 can be operated with a comparatively very high-activated-sludge concentration of more than 10 g TS/L, thus enabling correspondingly smaller basin volumes.

2. The part stream 2 is fed back as pre-treated percolate water recirculate (with sharply reduced nitrogen and carbon (=COD) concentrations) into the percolate water container of the dry fermentation process or directly into one of the fermentation chambers so as to achieve percolate water leaching that exceeds what can be achieved normally. This optimizes the biogas production and minimizes the methane emission into the atmosphere.

The excess percolate water,'too, is removed from the part stream 2 for indirectly charging or further treatment. This removal preferably takes place when implementing part stream 1 a since part stream 2 is then that water from the nitrification basin that has been purified to the highest degree.

3. The selective implementation of part stream 1a and part stream 1b can be used for, optimizing the process as follows: At the start of the percolate water leaching from the fermenting biowaste, 1a is implemented. This involves a gentle start of the leaching without inhibiting the biogas production to any extent worth mentioning since the part stream 2 then originates from the denitrification basin 10. At the end of the percolate water leaching it should be intensified by implementation of 1b. Part stream 2 (then from the nitrification basin) is then purified to a very high degree and percolate water leaching can be completed up to the complete leaching of the residual organics.

4. The part stream 1 continuously removed from the apex of the hopper 16 can be increased (manually or fully automatically) to such a large extent that the part stream 2 is free from activated sludge. Particularly at the end of the dry fermentation phase it is a direct and discernible advantage if the percolate water recirculation system is free from activated-sludge components.

Reference is now made to FIG. 2. The actual dry fermentation process can be carried out using two percolate water containers. The intake into the percolate water spraying system has a redundant design also for all fermentation chambers FIG. 1 -FIG. 6. In each case one intake is assigned to a percolate water container P 1, P 2. From each percolate water container different fermentation chambers can be supplied as selected. This redundance also applies to the return path of the percolate leachate.

The “conventional” percolate water recirculation with raw percolate water is carried out between percolate water container P 1 and all fermentation chambers F 1-F 6, as in the case of the previously known dry-fermentation percolation systems, with the exception of that one whose process is terminated next.

The percolate water container P 2 can serve for percolate water recirculation with the fermentation chamber that is emptied next; due to the redundant design of the return lines it is ensured that the percolate leachate from the fermentation chamber that is being sprayed from the percolate water container P 2 is really fed back into it. In addition, recirculation into the denitrification of the aerobic percolate water treatment takes place from this percolate water container P 2 or the bypass line BP1.

In FIG. 2 both percolate water containers P 1 and P 2 and six fermentation chambers F 1-F 6 are present. Each fermentation chamber F 1-F 6 is emptied for example every 6 weeks and filled with fresh material. This charging and emptying is carried out with an offset of in each case one week so that every week one emptying and charging procedure takes place.

At the start of week 1 fermentation chamber F 1 (that has undergone a six-week anaerobic fermentation) is opened and emptied and then charged again. Until it was opened, this chamber 1 has been sprayed during the entire previous week from the percolate water container P 2 (or directly from the part stream 2 run-offs of the nitrification basin 12 or the denitrification basin 10). After opening chamber F 1, spraying from the percolate water container P 2 is switched over to chamber F 2 until the start of week 2 etc. All other fermentation chambers F 1-F 6 that are not being sprayed from the percolate water container P 2 are sprayed from the percolate water container P 1.

In Table 1 this process is illustrated in a cycle strategy picture*)

| Week | 1 | 2 | 3 | 4 | 5 | 6 | 7 | 8 | 9 |
|---|---|---|---|---|---|---|---|---|---|
| F1 from P1 | x | x | x | x | x | | x | x | X |
| F1 from P2 | | | | | | x | | | |
| F2 from P1 | | x | x | x | x | x | | x | X |
| F2 from P2 | x | | | | | | x | | |
| F3 from P1 | x | | x | x | x | x | x | | X |
| F3 from P2 | | x | | | | | | x | |
| F4 from P1 | x | x | | x | x | x | x | x | |
| F4 from P2 | | | x | | | | | | X |
| F5 from P1 | x | x | x | | x | x | x | x | X |
| F5 from P2 | | | | x | | | | | |
| F6 from P1 | x | x | x | x | | x | x. | x | X |
| F6 from P2 | | | | | x | | | | |

*) x in Week 1 for F1 from P1 means the fermentation chamber F 1 is recirculated with the percolate water container P 1 in this week. x in Week 1 for F 2 from P 2 means that in this week the fermentation chamber F 2 is recirculated with the percolate water container P 2 (or part stream 2, see picture 1). It can be seen that starting with every new week the next fermentation chamber is assigned to the percolate water container P 2.

FIG. 2 illustrates schematically the entire process of dry fermentation including percolation: All of the six digester chambers F 1-F 6 can be charged individually via the percolate water container P 2 and shut-off valves P21 to P26. Under normal circumstances only one of these shut-off valves P21-P26 is open, and to be precise the one that is assigned to the digester that is going to be emptied next (as an example in FIG. 2 the shut-off valve P22 as per table 1). The other five digester chambers (F1 and F 3-F 6) are charged via the recirculation pumping station PP 1 from the percolate container P 1. Corresponding to this the leachate from the six digesters is guided differentially into the two percolate collecting shafts. PSS 1 (assigned to P 1) and PSS 2 (assigned to P 2). This correspondence lakes place via shut-off valves F11 to F26: Only F22, that is to say the connection from the digester chamber F2 to the percolate water shaft PSS 2, is open so that the percolate from F2 recirculates back into the percolate water container P 2 or is fed directly via the bypass BP1 to the aerobic posttreatment (see picture 1).

The excess percolate water connected to the percolate water container P 1 can be withdrawn wholly or in part from the percolate leachate of that digester that is connected to the percolate water container P 1 and is assigned next to the percolate water container P 2. In this example this is the digester chamber F 3. Among all digester chambers F 1-F 6 connected to the percolate water container P 1, the fermentation process has proceeded most in the digester chamber F 3 and the percolate leachate is thus least loaded. This assignment of a second digester chamber to the percolate water shaft PSS 2 can for example take place by means of a specification of the desired level in the percolate water container P 1: If this desired height has been exceeded the shut-off valve F23 is opened and the shut-off valve F13 is closed until a freely selectable amount has been withdrawn from the percolate water container P 1.

The shut-off valves of the other digester chamber F 4 or F 5 are open in the direction of the percolate water shaft PSS 1 from where recirculation into the percolate water container P 1 takes place.

After opening and emptying of F 2 the shut-off valve P22 is closed and the shut-off valve P23 is opened and also the shut-off valve F22 closed and the shut-off valve F23 opened.

The four or five digesters connected to the percolate water container P 1 are continuously producing excess percolate water. It is conveyed wholly or in part via a pumping station or overflow RZP1 into the percolate water container 2 if this excess does not take place via the percolate leachate of the digester chamber F 1-F 6 that is connected to the percolate water container P 1 and is most advanced in the fermentation process.

The excess percolate water produced in the percolate water container P1 is increased by precisely the amount of excess sludge from the downstream aerobic biology that is conveyed into the percolate water container P 1 according to a preferred embodiment of the invention.

Preferably even more than the excess percolate water mentioned above is conveyed via the recirculation pumping station RZP 1 or the percolate water recirculation shaft PSS 2 from the percolate water container P 1 into the percolate water container P 2. This additional amount has to be compensated, to be specific according to the invention by means of feeding back this additional amount from the percolate water container P 2 back into the percolate water container P 1 via the pumping station or the overflow RZP 2. The higher the recirculation of this additional amount, the lower the percolate water concentrations in the percolate water container P 1. The aim should be a recirculation of the additional amount that leads to an ammonia concentration in the percolate water container P 1 below the inhibiting concentration of biogas formation.

Recirculation of the percolate water treated in the aerobic biology takes place from the percolate water container P 2 back into the percolate water container P 2 via line PRZ. However, this recirculation can also take place via a bypass (BP 2) past the percolate water container P 2 and thus directly into the percolate water feeding line of the digester chamber F 1-F 6 that is connected to the percolate water container P 2. This intensifies the leaching intensity of the digester chamber F 1-F 6 concerned since the purified percolate water exhibits lower percolate water concentrations than the percolate water in the percolate water container P 2.

In FIG. 2:

F 1-F 6: digester chambers 1-6

P 1, P 2: percolate water containers 1 and 2

RZP 1 and RZP 2: recirculation pumping stations between P 1 and P 2

PP 1 and PP 2: percolation pumping stations

BP 1 and BP 2: Bypass lines around P 2

P11 . . . P26: shut-off valve for controlling the feeding of the digesters from P1 or P2. Pxy means that the digester chamber y is being fed from the percolate water container x.

F11 . . . F26: shut-off valve for controlling the feedback of percolate water from the digester chambers in P1 or P2. Fxy means that percolate water recirculate from the digester chamber x is being guided into the percolate water collecting shaft (PSS y) for feeding back into the percolate water container y.

PSS 1, PSS 2: percolate water recirculation shafts.

This novel process technology results in the following process characteristics:

1. Purified percolate water recirculate from the run-off/overflow of the Dortmund tank is continuously supplied to the percolate water container P 2 (or also optionally the digester chamber presently connected to this percolate water container), part stream 2, optionally with few or wholly without activated-sludge fractions. At the same time, percolate water recirculate is supplied to this percolate water container P 2 over a period of one week from the fermentation chamber F 2 whose fermentation process has progressed furthest and whose percolate water is thus largely fermented. During the course of this week the raw percolate water is leached out of the digester chamber F 2 and replaced by purified percolate water. During the course of this week the leaching process progresses further continuously until not only the percolate water per se is leached out but also further organic constituents of the biowaste are leached out. This leaching process can be intensified at will, for example by increasing the recirculation rate, according to the desired/required degree of leaching.

The percolate water recirculate is preferably then no longer supplied to the percolate water container P 2 in the event that it has reached a degree of purification that will not lead to any further formation of biogas in the percolate water container P 2. From then on this percolate water recirculate should be fed via the bypass line BP 1 (see FIG. 2) directly into the inlet of the aerobic biology.

Because of the continuous recirculation between anaerobic fermentation and aerobic percolate water purification, the percolate water organics can be reduced to almost any desired degree of degradation, apart from minimum amounts of organic components that can be degraded neither anaerobically nor aerobically. This reduction in terms of residual organics in the biowaste can therefore take place to such a large extent that the landfill criteria MBA/TA for municipal waste can be complied with.

2. The treated percolate water can be purified to indirect discharge quality. Since the steady-state concentration in terms of COD and NR₄—N in the percolate water container P 2 is many times lower than in the percolate water container P 1, activated-sludge populations will be established in the aerobic posttreatment stage that are particularly adapted for degrading the difficult-to-degrade COD fractions. A further advantage of this conception consists in that particularly highly-concentrated batches from the percolate water container P 1 are strongly diluted in the percolate water container P 2 and thus “make their mark” on the aerobic posttreatment only in a strongly buffered manner.

The purified wastewater withdrawn from the nitrification basin 12 is thus very well suited for optionally subsequent further-treatment stages such as ultrafiltration and reverse osmosis. A subsequent reverse-osmosis stage can purify the wastewater to direct discharge quality.

3. The biowaste treated in this way will emit no or only little methane gas into the atmosphere after emptying one of the digester chambers F 1-F 6 and leachate that may still be possibly produced will be loaded only to a very small degree.

1. Method for treating percolate water produced during dry fermentation using a first percolate water container (P 1) and a second percolate water container (P 2) and a plurality of ferment chambers (F 1-F 6), one of which is in each case charged from the second percolate water container (P 2), with the following steps:
charging a plurality of first fermentation chambers (F 1-F 5) from a first percolate water container (P 1) during a first period,
charging a further fermentation chamber (F 6) from a second percolate water container (P 2) during the first period,
feeding purified percolate water from the outlet/overflow of a sedimentation container (16) into the second percolate water container (P 2) or directly into a ferment chamber that is just being charged from the second percolation water container (P 1), from a plurality of ferment chambers (F 1-F 6) cyclically charged, from the second percolate container (P 2), and
feeding percolate water circulate from that ferment chamber in which the fermentation, process has advanced furthest, into the percolate water container (P 2).

2. Method according to claim 1, characterized by
introducing the percolate water into a denitrification basin (10),
conveying activated sludge from a nitrification basin (12) into the denitrification basin (10) via a sedimentation basin (16),
withdrawing a part stream (1) from the sedimentation basin (16),
pumping part (1a) of the part stream (1) into the nitrification basin (12),
removing the remaining part stream (2) that contains no or only little activated sludge from the sedimentation basin (16),
introducing excess sludge from the sedimentation basin (16) into the first percolate water container (P 1),
cyclically selecting a next fermentation chamber (F 2-F6) as first fermentation chamber or as a further fermentation chamber (F 1) after the period has elapsed,
feeding back the fermented percolate water from the (respective) further fermentation chamber (F6, F1) into the second percolate water container (P 2),
removing percolate from the second percolate water container (P 2) for treating it aerobically.

3. Method according to claim 1, characterized by pumping the excess sludge from the sedimentation basin into one of the percolate water containers (P 1, P 2).

4. Method according to claim 1, characterized by feeding the part stream (2) to one of the percolate water containers (P 1, P 2) for percolate spraying, for direct discharge, or for further treatment.

5. Method according to claim 1, characterized by feeding percolate produced in the second percolate water container (P 2) to aerobic percolate treatment.

6. Method according to claim 1, characterized by feeding the percolate water recirculate into the inlet of an anaerobic biology when a degree of purification is reached that does not lead to further formation of biogas in the percolate water container P 2.
